(19) United States
(12) Patent Application Publication
(10) Pub. No.: US 2015/0024719 A1
(43) Pub. Date: Jan. 22, 2015

(54) SYSTEM AND METHOD FOR CUSTOMIZED COMMUNICATIONS BASED UPON CONTACT RELATIONSHIPS

(71) Applicant: Vonage Network LLC, Holmdel, NJ (US)

(72) Inventors: Baruch STERMAN, Efrat (IL); Ido MINTZ, Burgata (IL); Sagie MACHLIN, Rishon LeZion (IL); Itay BIANCO, Tel-Aviv (IL); Tzahi Efrati, Hoboken, NJ (US)

(21) Appl. No.: 13/945,480

(22) Filed: Jul. 18, 2013

(51) Int. Cl. H04W 4/16

(52) U.S. Cl. CPC H04W 4/16
USPC 455/414.1

(57) ABSTRACT

A method and system for customized communication routing based on contact relationships including attempting to reach a first contact of a plurality of contacts in a contact list and determining that the attempt to reach the first contact failed. The method and system then invokes an alternative action to reach the first contact by an agency of at least one of the plurality of contacts. The alternative action is based on a relationship between the first contact and the plurality of contacts and includes contacting one or more second contacts through a voice call and/or contacting the first contact concurrent with one or more second contacts through a text message. The relationship between the first contact and the plurality of contacts may be determined based on information provided from one or more communication devices and/or based on information obtained from a social network.

### BACKGROUND OF THE INVENTION

1. Field of the Invention

The present invention generally relates to mobile devices and more particularly to methods and systems for managing customized communication routing based upon contact relationships.

2. Description of the Related Art

Telephony devices such as smartphones provide the ability to manage phone lists for users in what is commonly referred to as a contact list. The information that can be stored and utilized in the contact list ranges from the very basic (e.g., name and phone number) to the relatively more comprehensive (e.g., email address, picture, social networking accounts, etc.).

Many smartphones today are also capable of linking phone contacts for a user with other accounts associated with the user. For example, the user may have a Facebook® account, a Linkedin® account, and a Gmail® email account. Present telephone technology allows the contact list for this user to “link” information between each account. Then, by selecting a specific contact, this “linked” information may be presented as a single contact for the user's reference.

However, contact lists generally do not provide information regarding relationships between contacts. It is possible and indeed probable, however, that two or more of a user's contacts will have relationships with each another. These relationships may be based on family, friendships or business associations.

The availability of relationship information in a contact list provides possibilities for convenient automatic actions for a caller who has access to such a list. A contact may be unavailable to receive a call for unanticipated reasons such as a dead phone battery, being out of a service provider's area, or more serious reasons such as an injury or illness. The relationship information in a contact list may provide a means to reach a contact related to the unavailable party as an alternative to trying to reach the unavailable party. A mother may be unavailable but a daughter may be in the house with the mother and be reachable to relay the call itself or the subject of the intended call to the mother. A business associate may be conducting important negotiations which would be in jeopardy if the associate failed to receive a call.

Accordingly, there is a need to provide a method and system that can derive relationship connections between contacts to a user which can then be used to provide convenient automated actions where the intended recipient is unavailable.

### SUMMARY OF THE INVENTION

A method and system for customized communication routing based on contact relationships including attempting to reach a first contact of a plurality of contacts in a contact list and determining that the attempt to reach the first contact failed. The method and system then invokes an alternative action to reach the first contact by an agency of at least one of the plurality of contacts. The alternative action is based on a relationship between the first contact and the plurality of contacts and includes contacting one or more second contacts through a voice call and/or contacting the first contact concurrent with one or more second contacts through a text message. The relationship between the first contact and the plurality of contacts may be determined based on information provided from one or more communication devices and/or based on information obtained from a social network.

Other and further embodiments of the present invention are described below.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a diagram of a communications environment that includes an IP telephony system capable of obtaining information regarding contacts and of using that information to determine relationships of the contacts in contact lists;

FIG. 2 is a diagram of an IP telephony system that may be used to practice one or more embodiments of the present invention;

FIG. 3 is a diagram of elements of a computer processor that may be used to practice one or more embodiments of the present invention;

FIG. 4 is a diagram illustrating steps of a method for determining a relationship between contacts in a contact list;

FIG. 5 is a diagram illustrating steps of a method for executing a first alternative action following a failure to connect to a first contact;

FIG. 6 is a diagram illustrating steps of a method for executing a second alternative action following a failure to connect to a first contact;

FIG. 7 is a diagram of elements of a communication device that may be used to practice one or more embodiments of the present invention; and

FIG. 8 is a diagram illustrating steps of a method performed on a communication device for determining a relationship between one or more contacts in contact list.

To facilitate understanding, identical reference numerals have been used, where possible, to designate identical elements that are common to the figures. The figures are not drawn to scale and may be simplified for clarity. It is contemplated that elements and features of one embodiment may be beneficially incorporated in other embodiments without further recitation.

### DETAILED DESCRIPTION

In the following description, references will be made to an “IP telephony device.” This term is used to refer to any type of device which is capable of interacting with an IP telephony system to complete an audio or video telephone call or to send and receive text messages, and other forms of communications. An IP telephony device could be an IP telephone, a computer running IP telephony software, a telephone adapter which is itself connected to a normal analog telephone, or some other type of device capable of communicating via data packets. An IP telephony device could also be a cellular telephone or a portable computing device that runs a software application that enables the device to act as an IP telephone. Thus, a single device might be capable of operating as both a cellular telephone and an IP telephone.

While the invention has been described in connection with IP telephony systems, it is to be understood that the invention is not to be limited to the disclosed embodiment, but on the contrary, is intended to cover various modifications and equivalent arrangements included within the spirit and scope of the appended claims including public switched telephone networks (PSTN).

Moreover, certain devices that are not traditionally used as telephony devices may act as telephony devices once they are configured with appropriate client software. Thus, some devices that would not normally be considered telephony devices may become telephony devices or IP telephony devices once they are running appropriate software. One example would be a desktop or a laptop computer that is running software that can interact with an IP telephony system over a data network to conduct telephone calls. Another example would be a portable computing device, such as an Apple iPod Touch™, which includes a speaker and a microphone. A software application loaded onto an Apple iPod Touch™ can be run so that the Apple iPod Touch can interact with an IP telephony system to conduct a telephone call.

Some portions of the detailed description which follow are presented in terms of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

Whereas currently available methods such as call forwarding are limited to predetermined actions based on unavailability of the intended recipient, the embodiments of the invention described herein allow a more expansive and flexible method and system of addressing unavailable intended recipients even where no call handling rule has been set up in advance.

The method and system described herein allows relationship connections to be derived between contacts of a user. The method and system then leverage those related contacts as agents to assist in contacting the unavailable intended recipient.

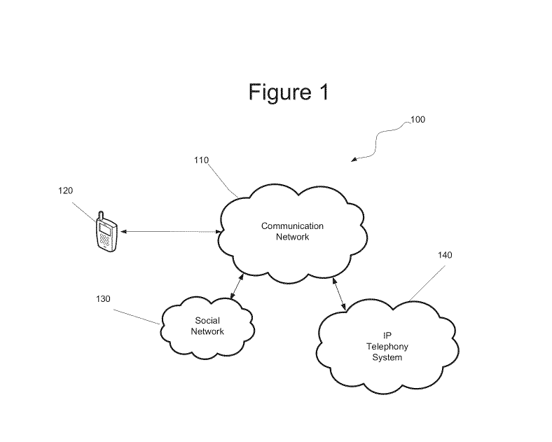

FIG. 1 is an illustration of an exemplary communication environment 100 including a communication network 110, a first communication device 120 such as an IP telephony device and an IP telephony system 140. The communication network 110 could be a public data network such as the Internet, or a private data network. Also, the communication network 110 illustrated in FIG. 1 could comprise both private data networks and public data networks.

Although only one communication device 120 is shown in FIG. 1, it should be appreciated that the IP telephony system 140 can communicate with multiple communication devices.

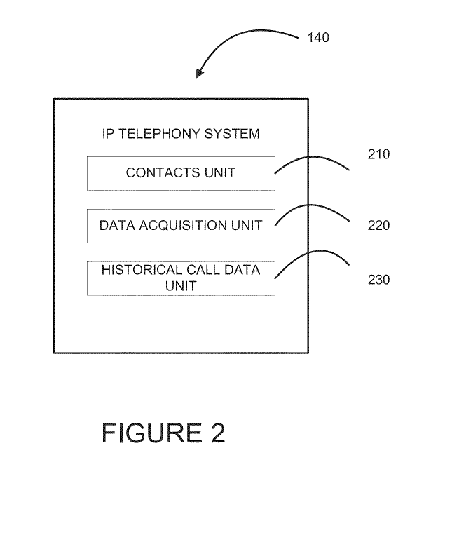

As an example, the communications device 120 can be a smartphone that stores one or more contact lists using a memory in the communications device 120. The communications device 120 may synchronize the contact list with the IP telephony system 140. The IP telephony system 140 can store and/or manage contact lists and information about contacts in a contacts unit 210 as shown in FIG. 2 and described in greater detail below. The IP telephony system 140 can retrieve and maintain information regarding one or more contacts with a data acquisition unit 220 of FIG. 2, as will be described in detail below. It should also be appreciated that each communication device 120 may have more than one contact list stored in the device 120. Likewise, the IP telephony system 140 can manage multiple contact lists for one or more communication devices 120.

Social network 130 is also in communication with communication network 110. Social network 130 may contain contact information which can be retrieved in accordance with embodiments of the present invention as will be discussed below.

FIG. 2 is a schematic diagram of an IP telephony system 140. The IP telephony system 140 includes a contacts unit 210 which stores contacts, contact lists, and information about the contacts. A data acquisition unit 220 obtains information regarding contacts, and that information can be stored in the contacts unit 210. Historical call data unit 230 of the IP telephony system 140 stores information about with whom individual contacts have communicated with in the past. This can include information about outgoing calls placed by a contact, as well as information about incoming calls received by a contact. This could also include information about other forms of communication that have been sent by or received by a contact, such as text message.

Contacts unit 210 of the IP telephony system 140 uses information regarding contacts obtained by the data acquisition unit 220, from communication device 120, from the historical call data unit 230, and from other sources to determine whether and how to modify how a contact is displayed in a contact list. The ways in which the display of contacts can be modified, and the reasons for doing so, are discussed in detail below.

The data acquisition unit 220 of IP telephony system 140 is configured to obtain information regarding contacts from one or more information sources. The information sources can include servers and information gateways accessible over the communication network 110.

The data acquisition unit 220 is also able to obtain information regarding a contact from one or more social networks 130. For example, a contact may have a Facebook® account, and a variety of items of information for the contact may be present within Facebook®. This information could include, but is not limited to, a home address, place of employment, current address, etc. The data acquisition unit 220 can obtain such information from a social network 130 and utilize and store the information in the contacts unit 210. This contact information can then be conveyed to a communication device 120 and also used to determine how to display a contact in a contact list.

A social network 130 is also capable of providing various other items of information. For example, a social network 130 can provide information related to the contact's friends/connections listed on the social network 130. That is, John Smith may have various “connections” in his social network account and this information may be obtained by the data acquisition unit 220.

In some instances, such as where a contact is a member of a social network 130, and also a customer of the IP telephony system 140, the contact may have provided the IP telephony system 140 with permission to obtain information from the contact's account with the social network 130. The contact may have also provided the IP telephony system 140 with the contact's credentials on the social network 130, in the form of a user name and password, so that the IP telephony system 140 can log into the social network 130 to review and retrieve information from the contact's account on the social network 130. In some instances, the IP telephony system 140 may have received authorization from a user to access certain information on a social networking system, and the IP telephony system 140 may be able to access this information without manually logging into the social networking system with the user's name and password.

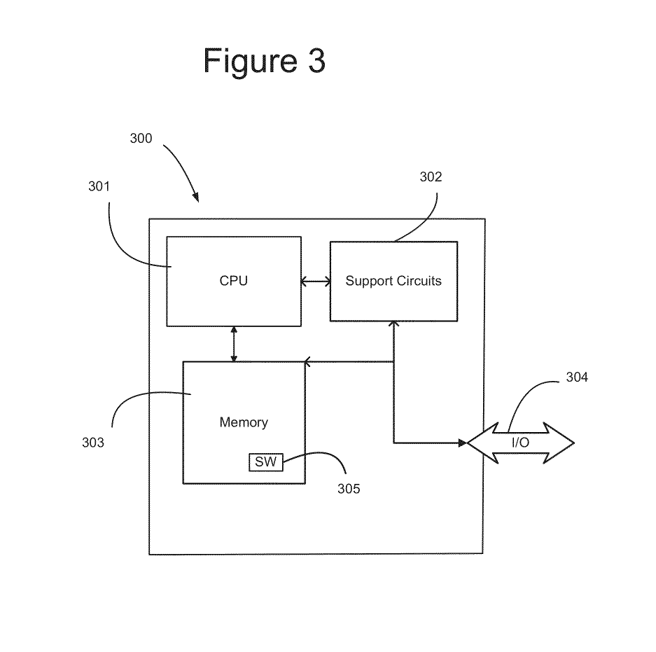

FIG. 3 illustrates elements of a computer processor 300 that can be incorporated in elements of the IP telephony system 140 to accomplish various functions. The IP telephony system 140 could utilize multiple processors 300 located at various locations, along with their own operating components and programming, each carrying out a specific or dedicated portion of the functions performed by the IP telephony system 140.

The processor 300 shown in FIG. 3 may be one of any form of a general purpose computer processor used in operating an IP based communication system 140. The processor 300 comprises a central processing unit (CPU) 301, a memory 303, and support circuits 302 for the CPU 301. The processor 300 also includes I/O interface 304 for connecting the processor 300 to customer equipment via one or more access point and a data channel, as well as possibly one or more input/output devices (not shown) for accessing the processor and/or performing ancillary or administrative functions related thereto.

The memory 303 is coupled to the CPU 301. The memory 303, or computer-readable medium, may be one or more of readily available memory such as random access memory (RAM), read only memory (ROM), floppy disk, hard disk, flash memory or any other form of digital storage, local or remote, and is preferably of non-volatile nature. The support circuits 302 are coupled to the CPU 301 for supporting the processor in a conventional manner. These circuits include cache, power supplies, clock circuits, input/output circuitry and subsystems, and the like.

Software routine 305, when executed by the CPU 301, causes the processor 300 to perform processes of the disclosed embodiments, and is generally stored in the memory 303. The software routine 305 may also be stored and/or executed by a second CPU (not shown) that is remotely located from the hardware being controlled by the CPU 301. Also, the software routines could also be stored remotely from the CPU. For example, the software could be resident on servers and memory devices that are located remotely from the CPU, but which are accessible to the CPU via a data network connection.

The software routine 305, when executed by the CPU 301, transforms the general purpose computer into a specific purpose computer that performs one or more functions of the IP telephony system 140. Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine 305 of the disclosed embodiments is capable of being executed on any computer operating system, and is capable of being performed using any CPU architecture.

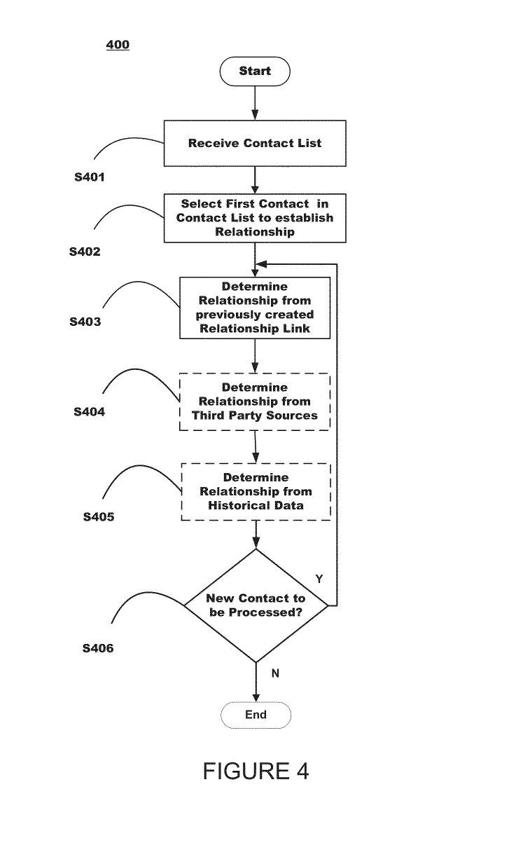

FIG. 4 is a diagram illustrating steps of a method 400 for determining a relationship between one or more contacts in contact list 220 and then using that relationship to instruct a telephony device about how to use that relationship to perform automated actions. The method 400 illustrated in FIG. 4 could be performed by elements of IP telephony system 140 multiple times, at least one time for each contact list.

The method begins and proceeds to step S401 where the IP telephony system 140 receives a contact list. The contact list could be obtained from a communication device 120. In one example, the device 120 can communicate the list to the IP telephony system 140. Alternatively, the IP telephony system 140 can store and manage the contact list for the device 120.

At step S402, the IP telephony system 140 selects the first contact on the list for which to establish relationship information.

At step S403, the IP telephony system 140 determines the relationships between the first contact and a second contact in the contacts unit 210. In step S403, the IP telephony system 140 receives the relationship information from existing information in contacts unit 210. The contact list may have an option to “create relationship” option for which a user may have previously selected the relationship for the first and second contact. The type of relationship includes family, friends, business, school and the like. Thus, one possible step for determining relationship information is by receiving the information that has been previously created.

In step S404, if the relationship information does not already exist, IP telephony system 140 can determine relationship information for the first and second contacts from one or more social networks 130. For example, Facebook® allows users to associate themselves as having a special relationship with another user. Data acquisition unit 220 is also able to obtain the relationship information regarding the contact from social networks 130 as described above.

In step S405, if the relationship information has not been determined in steps S403 and S404, IP telephony system 140 determines the relationship information for the first and second contacts from historical data 230. For example, relationship information may be derived from historical data 230 containing frequent communications with a contact and would determine that the contact is a related contact. Alternatively, historical data 230 may indicate that failed attempts by a user to reach a specific contact often are followed immediately by attempts to reach a second contact. Also, several contacts may frequently conference together or send emails together and IP telephony system 140 can determine that there is a relationship between the contacts.

Moreover, for each of the steps S403-S405, IP telephony system 140 can infer not only that a relationship exists but the type of the relationship between a first and second contact in the contacts unit 210 from historical data 230. For example, if the first and second contact share the same residential address, IP telephony system 140 may determine that they are family members. Another example is the first and second contact sharing the email address domain of a school. The IP telephony system 140 may determine that the first and second contacts are classmates. Also, each of the steps S403-S405 is not required. Any one or any combination of the steps S403-S405 may be employed to determine that a relationship exits and the type of relationship.

Rules for determining relationship types may be provided to the system governing additional types of relationships. Alternatively, the relationship type may be pulled from the relationship information available in the social networks 130.

In step S406, the method determines if there is another contact in contacts unit 210 for which to determine a relationship. If so, the process continues back to step S403 for this contact and continues through each contact in contacts unit 210 until all of the contacts have been exhausted. When all of the contacts in contacts unit 210 have been processed for a relationship determination, the method ends.

Having established a contact relationship the method proceeds to provide convenient automated actions.

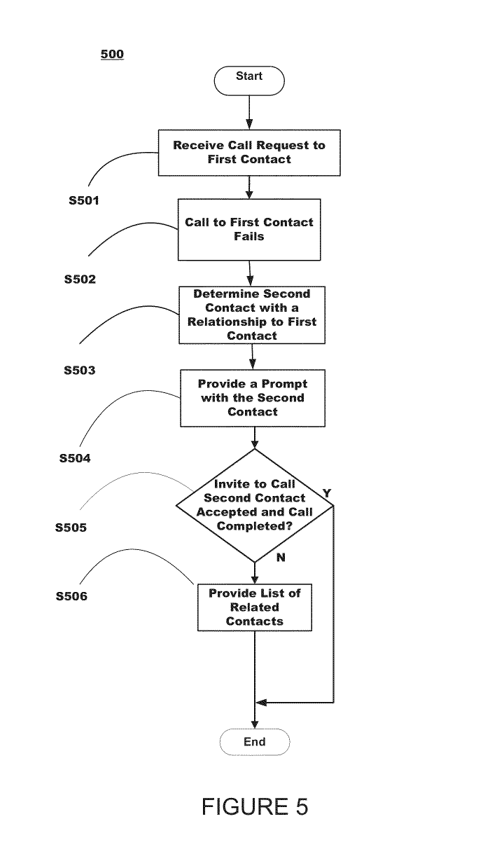

FIG. 5 is a diagram illustrating steps of a method 500 for executing an action following a failure to connect to a first contact. The method 500 illustrated in FIG. 5 would be performed by elements of IP telephony system 140.

The method begins and proceeds to step S501 in which IP telephony system 140 receives a call request, for example, from communication device 120 for a call to a first contact in contacts unit 210.

At step S502, the call to the first contact fails. The call failure may be due to the call being ignored by the first contact or the first contact communication device is unavailable to receive a call because the device is off, out of a service area or a battery failure, for example.

Proceeding to step S503, IP telephony system 140 determines a second contact in contacts unit 210 that shares a relationship with the first contact as determined in the method 400 above.

At step S504, IP telephony system 140 provides a prompt to communication device 120 with the second contact information and an invitation to call the second contact.

At step S505, IP telephony system 140 determines if the call invitation to the second contact has been accepted. If so, the IP Telephony system 140 proceeds with a call attempt to the second contact. If the call invitation is completed (i.e. the second party answers the phone call), the method ends with the call to the second contact connected. If the call invitation is not completed, at step S506, IP telephony system 140 delivers a list of all contacts with a relationship to the first contact to communication device 120.

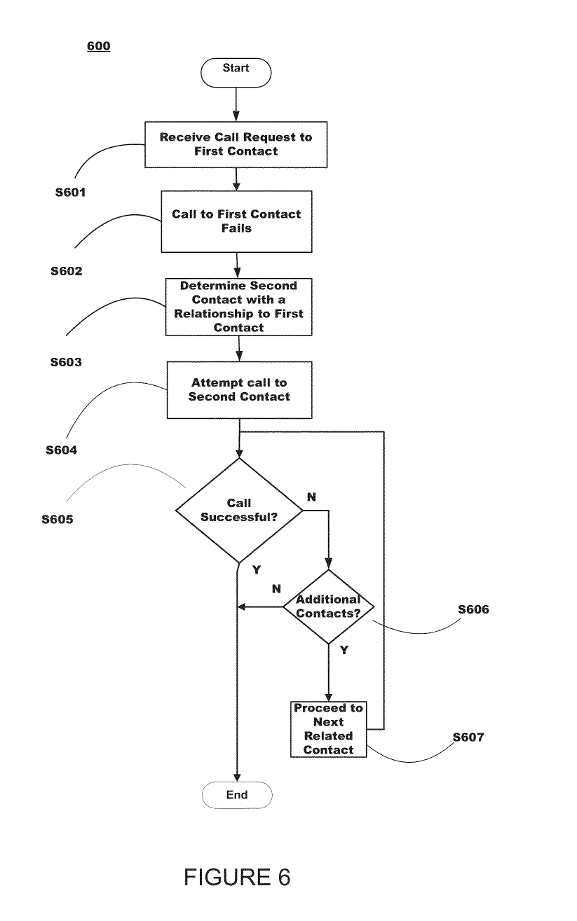

FIG. 6 is a diagram of steps for a method 600 for executing a first alternative action following a failure to connect to a first contact. The method 600 illustrated in FIG. 6 would be performed by elements of IP telephony system 140.

The method begins and proceeds to step S601 where the IP telephony system 140 receives a call request from communication device 120 for a call to a first contact in contacts unit 210.

At step S602, the call to the first contact fails. Proceeding to step S603, IP telephony system 140 determines a second contact in contacts unit 210 sharing a relationship with the first contact as determined in the method 400 above.

At step S604, IP telephony system 140 automatically attempts a call to the second contact.

At step S605, IP telephony system 140 determines if the call to the second contact is successful. If so, the call to the second contact has been completed and the method ends. If the call to the second contact is not successful, the method proceeds to step S606 to check for additional contacts. If there are additional contacts, the method continues to step S607 where the IP telephony system 140 proceeds to the next contact at in contacts unit 210 with a relationship to the first contact and returns to step S605 where the IP telephony system 140 attempts to call such next contact. The process continues through each contact in contacts unit 210 until a call to a related contact is achieved or the list of related contacts is exhausted at step S606.

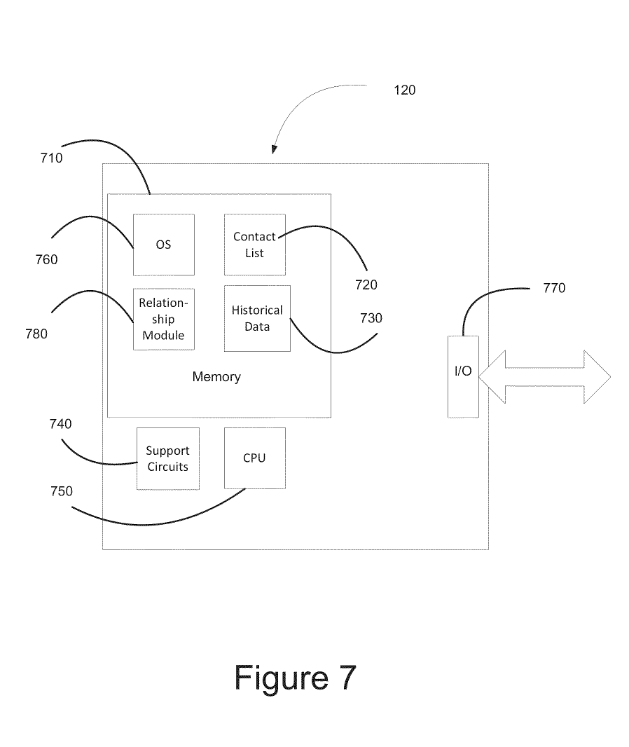

In another embodiment, FIG. 7 depicts an exemplary diagram representation of elements of communication device 120. Communication device 120 includes memory 710, support circuits 740, a CPU 750, and input/output (I/O) interface 770. The support circuits 740 include circuits for interfacing with the CPU 750 and I/O interface 770. The I/O interface 770 may also include a speaker, microphone, touch screen, buttons and the like for a user to interact with the communication device 120.

The memory 710 includes an operating system 760, contact list 720, historical data 730 and relationship module 780. The operating system 760 controls the interoperability of the support circuits 740, CPU 750, memory 710 and the I/O interface 770.

Relationship module 780 when executed by the CPU 750, causes communication device 120 to perform processes of the disclosed embodiments, and is generally stored in a memory or computer-readable medium, which may be one or more of readily available memory such as random access memory (RAM), read only memory (ROM), floppy disk, hard disk, flash memory or any other form of digital storage, local or remote, and is preferably of non-volatile nature.

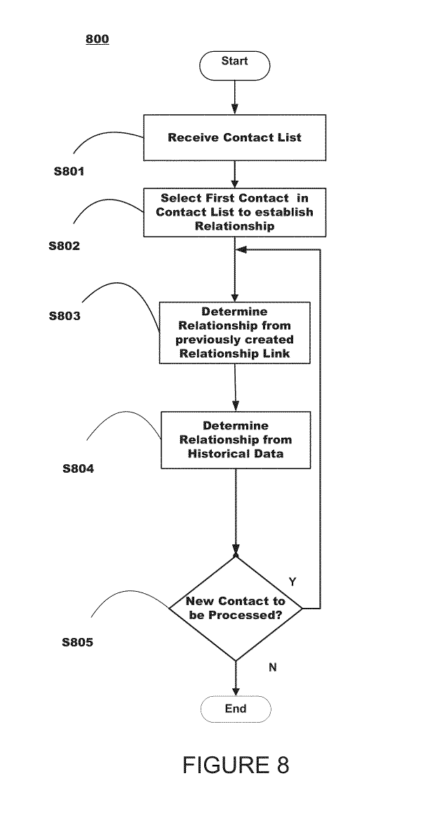

FIG. 8 is a diagram illustrating steps of a method 800 performed on communication device 120 for determining a relationship between one or more contacts in contact list 720 and then using that relationship to instruct communication device 120 about how to use that relationship to perform automated actions. The method 800 illustrated in FIG. 8 would be performed by elements of communication device 120 multiple times, at least one time for each contact list.

The method begins and proceeds to step S801 where the relationship module 780 accesses contact list 720. At step S802, relationship module 780 selects the first contact on the list for which to establish relationship information. In step S803, the relationship module 780 determines the relationships between the first contact and a second contact in the contact list 720. In step S803, the relationship module 780 receives the relationship information from existing information in contact list 720. The contact list may have an option to “create relationship” option for which a user may have previously selected the relationship for the first and second contact. The type of relationship includes family, friends, business, school and the like.

In step S804, if the relationship information does not exist, relationship module 780 determines the relationship information for the first and second contacts from historical data 730. For example, relationship information may be derived from historical data 730 as described in step S405 of method 400.

In step S805, the method determines if there is another contact in contact list 720 which to determine a relationship. If so, the process continues back to step S803 for this contact and continues through each contact in contacts list 720 until all of the contacts have been exhausted. When all of the contacts in contacts list 720 have been processed for a relationship determination, the method ends.

Having established a contact relationship the method proceeds to method 500 and 600 as described in FIGS. 5-6 to provide convenient automated actions.

In one embodiment, the list provided in step S506 may be grouped by type. For example, the groups may include friends, family, business associates and the like.

In one embodiment, an auto-populated email or SMS may be provided as alternative to proceeding to other related contacts of step S606 of method 600. The email or SMS would be populated with the email addresses of all the related contacts with a generic message or a customizable message.

In another embodiment, the email or SMS may be populated with one contact and a list of all contacts from step S506 of method 500 may be provided to allow messages to be sent to selected related contacts from the lists.

In another embodiment, the email or SMS may be populated with specific groups of contacts from the list of all contacts in step S506.

In another embodiment, step S606 of method 600 may provide an automatic conference call to all the related contacts rather than proceeding to each individual contact.

In another embodiment, a one-touch option may be provided at step S504 of method 500 to facilitate a call to the second contact.

In another embodiment, a one-touch option may be provided to all the listed contacts at step S506 of method 500 to facilitate a call to the contact.

In another embodiment, the automated calls of steps S604-S606 may provide a choice on whether or not to proceed with automatic calling and the ability to abort the process.

In other embodiments, contact relationships may be based on configuration parameters set by the user. For example, all contacts that have a particular telephone exchange number are related as business associates. Other examples include the user setting the relationship type (i.e. family members, business associates, etc.).

In another embodiment, the historical data in step S405 may include data on a contact frequently called after the first contact fails to be reached. Step S405 of method 400 may determine the relationship of a frequent contact to the first contact based on the frequent calls. The relationship may be referred to as a preferred contact. The preferred contacts may be grouped as a type of relationship.

In another embodiment, the communication device 120 may include a display. The display may show the list of contacts and further include the relationship type.

In other embodiments, a business partner involved in contract negotiations may be unavailable but a related contact in the business may be contacted in accordance with methods of the invention and be available to act on the unavailable partner's behalf or have additional access in contacting the unavailable partner.

In another embodiment, a family member may be unavailable to receive an urgent message but another family member may be contacted in accordance with methods of the invention and may be able to contact the unavailable family member or relay the message to the unavailable family member.

Although the processes of the disclosed embodiments may be discussed as being implemented as a software routine, some of the method steps that are disclosed therein may be performed in hardware as well as by a processor running software. As such, the embodiments may be implemented in software as executed upon a computer system, in hardware as an application specific integrated circuit or other type of hardware implementation, or a combination of software and hardware. The software routine of the disclosed embodiments is capable of being executed on any computer operating system, and is capable of being performed using any CPU architecture.

The methods described herein may be implemented in software, hardware, or a combination thereof, in different embodiments. In addition, the order of methods may be changed, and various elements may be added, reordered, combined, omitted or otherwise modified. All examples described herein are presented in a non-limiting manner. Various modifications and changes may be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

While the foregoing is directed to embodiments of the present invention, other and further embodiments of the invention may be devised without departing from the basic scope thereof, and the scope thereof is determined by the claims that follow.

What is claimed is:

1. A method for customized communication routing based upon contact relationships comprising:
attempting to reach a first contact of a plurality of contacts in a contact list;
determining that the attempt to reach the first contact failed; and
invoking an alternative action to reach the first contact by an agency of at least one of the plurality of contacts.

2. The method of claim 1, wherein the alternative action is based on a relationship between the first contact and the at least one of the plurality of contacts.

3. The method of claim 2, wherein the alternative action comprises attempting to contact a second contact in the contact list based on its relationship to the first contact.

4. The method of claim 2, wherein the alternative action comprises delivering a list including at least a second contact based on the relationship to the first contact.

5. The method of claim 2, wherein the alternative action further comprises contacting one or more second contacts through a voice call.

6. The method of claim 2, wherein the alternative action further comprises contacting the first contact and one or more second contacts through at least one text message.

7. The method of claim 2, wherein the relationship between the first contact and the at least one of the plurality of contacts is determined based on information provided from one or more communication devices.

8. The method of claim 2, wherein the relationship between the first contact and at least one of the plurality of contacts is determined based on information obtained from at least one social network.

9. The method of claim 2, wherein the relationship between the first contact and at least one of the plurality of contacts is determined based on information obtained from historical data.

10. The method of claim 2, wherein the relationship between the first contact and at least one of the plurality of contacts comprises relationship type.

11. The method of claim 10, wherein the relationship type comprises a family, a friend, a business or an association.

12. A system for customized communication routing based upon contact relationships comprising:
a processing unit; and
a contacts unit,
wherein the processing unit is configured to:
attempt to reach a first contact of a plurality of contacts in a contact list;
determine that the attempt to reach the first contact failed; and
invoke an alternative action to reach the first contact by an agency of at least one of the plurality of contacts.

13. The system of claim 12, wherein the alternative action is based a relationship between the first contact and at least one of the plurality of contacts.
